(19) United States
(12) Patent Application Publication
(10) Pub. No.: US 2007/0282676 A1
(43) Pub. Date: Dec. 6, 2007

(54) AUTOMATED RESPONDER TARGETING

(75) Inventor: Thomas A. Kehl, Palo Alto, CA (US)

Correspondence Address: BEYER WEAVER LLP, P.O. BOX 70250, OAKLAND, CA, 94612-0250, US

(73) Assignee: YAHOO! Inc., Sunnyvale, CA (US)

(21) Appl. No.: 11/421,191

(22) Filed: May 31, 2006

(51) Int. Cl. G06Q 30/00

(52) U.S. Cl. 705/14

(57) ABSTRACT

Presentation of media of a particular campaign via a network, to which a plurality of client computers are connectable, is managed. The particular campaign is to present media of the campaign to the client computers for response evocation. An event is received indicating that media of the campaign is to be provided to a particular client computer via the network. Indications of responses to primary media of the campaign are processed and, based thereon and in response to receiving the event indicating that media of the campaign is to be provided to the particular client computer, one of primary media of the campaign and secondary media of the campaign is selected to provide to the particular client computer via the network. The indications of responses are automatically maintained based at least in part on whether the particular client computer responds to the primary media of the campaign.

### BACKGROUND

Much effort is being put into targeting advertising to internet users who are most likely to have interest in what is being advertised. Typically, the more targeted an advertisement can be shown to be, the more an advertising provider can charge for that advertisement.

In one conventional example, indications of responders (e.g., those who clicked on advertisements of a particular original advertising campaign) are processed during a subsequent advertising campaign much later (e.g., months later) for what is deemed to be a related product. For example, the first advertising campaign may be for a first movie, and the subsequent advertising campaign may be for another movie in which those interested in the first movie may also be interested.

In another conventional example, a first phase of an advertising campaign is run for a set period of time (such as one day), then the indications of responders are processed during a subsequent period of time (such as three days) and subsequent advertising is targeted at those who indicated an interest in the advertised product and/or service.

Interestingly, in both examples, the goal is to sell subsequent advertising targeted at initial responders, rather than accentuating the success of the original advertising campaign.

### SUMMARY

A method and system is provided to manage presentation of media of a particular campaign via a network to which a plurality of client computers are connectable. The particular campaign is to present media of the campaign to the client computers for response evocation. An event is received indicating that media of the campaign is to be provided to a particular client computer via the network. For example, the event may be a result of a search query that corresponds to the advertising campaign or may be a result of action by the client computer to cause a browser to display a page whose content includes keywords that correspond to the advertising campaign.

Indications of responses to primary media of the campaign are processed and, based thereon and in response to receiving the event indicating that media of the campaign is to be provided to the particular client computer, one of primary media of the campaign and secondary media of the campaign is selected to provide to the particular client computer via the network. The indications of responses are automatically maintained based at least in part on whether the particular client computer responds to the primary media of the campaign.

### BRIEF DESCRIPTION OF THE DRAWINGS

FIG. 1 is a flowchart illustrating an example of processing to selectively display primary advertisements and secondary advertisements of an advertising campaign.

FIG. 2 is a timeline illustrating an example result of the FIG. 1 processing.

FIG. 3 is a block diagram illustrating an example architecture of a system in which the FIG. 1 method may operate.

### DETAILED DESCRIPTION

One goal of an advertising campaign is to obtain conversions—for example, converting a user viewing an advertisement into a buyer by obtaining completion of a purchase of an item being advertised. There are numerous other examples of converting, and the determination of whether a user has converted with respect to a particular advertising campaign is a function of how conversion is defined with respect to that particular advertising campaign. Merely clicking on or otherwise exhibiting preliminary interest in the primary material being displayed is not converting, however.

It is desired to efficiently handle responder targeting to, for example, target individual responders (i.e., users who respond) to advertisements based on characteristics of those responders and/or their response. Users who respond to primary advertising material, but who do not convert, are appropriately targeted with subsequent secondary advertising material. The secondary advertising material is typically more focused on obtaining a conversion, with respect to the subject matter of the primary advertising material, from that user.

Leads (i.e., responders to initial advertisements) can quickly cool off. Thus, in accordance with an aspect, a method is provided to log responders to primary media (such as primary advertisements) of a particular campaign, and to present secondary media for the campaign to such logged responders, as appropriate, based on characteristics of that individual responder and of that individual responder's response. The log may be automatically maintained in a manner appropriate to each particular advertising campaign.

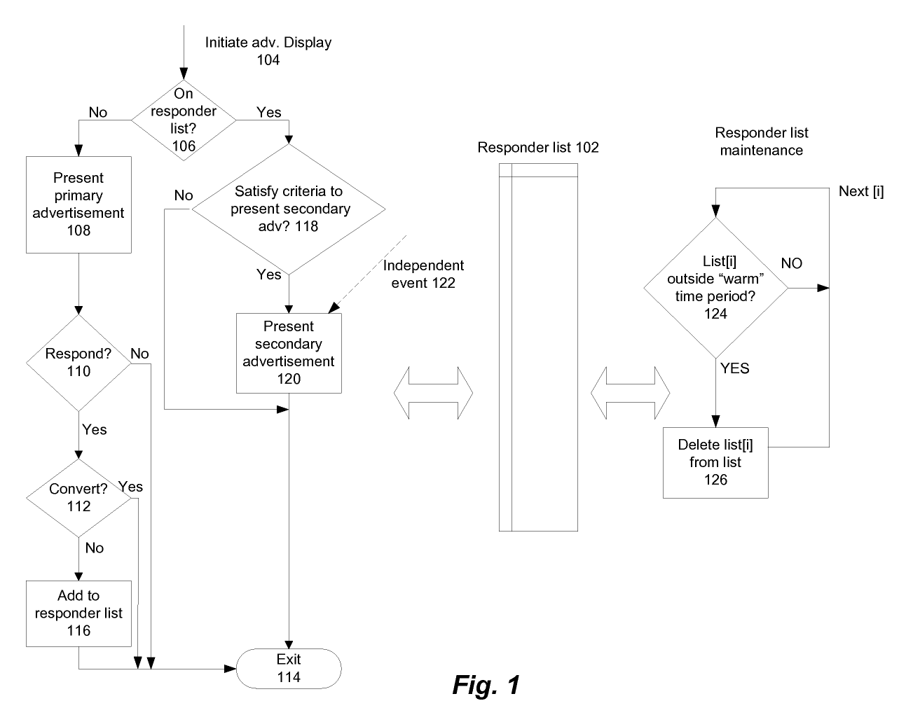

FIG. 1 is a flow chart illustrating a responder targeting method at a high level. Referring to FIG. 1, a log of responders is shown implemented as responder list 102. For example, the responder list 102 may include an entry, for each responder, that indicates an identification of that responder and also indicates properties of the responder's response (such as the time of the response). Information about a user, including information that can be used to uniquely identify the user (even if the user remains anonymous) is typically obtained from the user (using a client computing device such as a personal computer or other computing device) by means of browser cookies although other methods of obtaining such information may be used as well. As is discussed later, the processing shown in the left side of FIG. 1 is processing to populate the responder list 102 and to process entries of the responder list to determine whether to present primary advertising material or secondary advertising material, or perhaps no advertising at all, based on an advertising display event 104. The processing shown in the right side of FIG. 1 is to selectively delete responders from the responder list 102 (or to otherwise indicate not to provide secondary advertising material to particular responders).

In some examples, the responder list 102 is maintained in a decentralized manner, with information for a particular user being maintained at the computing device. For example, the information about a particular responder user may be contained within a cookie at that user's computer, and maintenance on the information may be performed when there is an opportunity to consider the cookie (such as when another event is provided for that user, or when a “related” web page is being viewed, such that the maintenance can be performed based on processing associated with that related web page).

Turning now to FIG. 1 in detail, reference numeral 104 refers to an event to initiate display, to a user, of an advertisement of an advertising campaign. Such an event may be, for example, a result of “sponsored search” processing by which a user requests a search engine to generate search results based on search query keywords provided by the user. In addition to causing search results to be displayed, the search engine (or software associated with or otherwise in communication with the search engine) also causes one or more sponsored advertisements to be displayed to the user based on the search query keywords provided by the user. Typically, the advertisements are displayed visually, although other examples include “display” for sensory perception other than visual. In the following description, the search query keywords are considered to result in the search engine causing display of advertisements of particular advertising campaigns, rather than of particular advertisements. In another example, the event is a result of processing a displayed web page for particular keywords, similar to the sponsored search processing. As another example, the event may be a result of action by the client computer to cause a browser to display a page whose content includes keywords that correspond to the advertising campaign

At step 106, it is determined if the user to whom the display of an advertisement is to be initiated is on the responder list 102 (or, for example, by referring to a locally maintained indication for that user). If the user is on the responder list 102, then the user has already responded to primary advertising material of the advertising campaign. If it is determined that the user is not on the responder list 102, then at step 108, primary advertising material is caused to be presented to the user.

At step 110, it is determined whether the user responded to the primary material caused to be presented at step 108. Typically, the determination as to whether the user responded to the primary material is a determination of whether the user indicated the primary material by clicking on the primary material displayed to the user via a browser program executing on one of many client computers to which the advertising campaign is being served. (Other user-initiated events that, in some examples, are considered to be the user responding to the material include downloading an instant messaging environment and viewing a movie trailer.) That is, a user would typically click on the primary material displayed to cause other material to be displayed, in the hopes (by the advertiser) of the user eventually “converting.”

If it is determined at step 110 that the user did not respond to the primary material caused to be presented at step 108, then processing exits at step 114. However, if it is determined at step 110 that the user did respond to the primary material caused to be presented at step 108, then processing continues at step 112. At step 112, it is determined if the user has converted with respect to the advertising campaign. If it is determined at step 112 that the user has converted with respect to the advertising campaign, then processing exits at step 114.

On the other hand, if it is determined at step 112 that the user has not converted with respect to the advertising (remembering that, at step 110, it was determined that the user responded to the primary material caused to be presented at step 108), then at step 116 the user is added to the responder list 102. As will be seen, upon subsequent events 104 to initiate display of an advertisement, of the advertising campaign, to the user, the presence of an indication of the user in the responder list 102 affects the processing that is carried out.

In particular, if it is determined at step 106 (after an event 104 to initiate display of an advertisement) that the user is on the responder list 102, then it is determined at step 118 if criteria is satisfied to cause secondary material of the advertising campaign to be presented to the user. In one example, the criteria that the user has not responded to the primary material less than a particular amount of time before the event 104 that would otherwise result in causing display of the secondary material, then processing exits at step 114. That is, in this example, it is deemed that at least the particular amount of time should pass between displaying the primary material and displaying the secondary material, to minimize irritation to users.

In many examples, then, the responder list 102 includes, in a record for each responder, information indicating properties of the responder user and of her activities relative to the advertising campaign. For example, the record for a particular responder user may include a time associated with the response to the primary material that caused a record for the responder user to be added to the responder list 102. This information can be used, for example, in the step 118 processing to determine if criteria is satisfied to cause secondary material of the advertising campaign to be presented. This information can also be used in the process of maintaining the responder list 102.

Returning again to the discussion of step 118, if it is determined at step 118 that the particular criteria is satisfied to cause display of the secondary material, then processing continues at step 120, where the secondary material is caused to be displayed. In addition to including an indication of a time associated with the response to the primary material that caused a record for the responder user to be added to the responder list 102, the record for a particular responder user may also include, for example, one or more times at which secondary material was presented to the responder user. After step 120 processing, processing exits at step 114.

The discussion thus far of FIG. 1 has illustrated an example process to track responses by users to primary material of an advertising campaign and, based thereon, to selectively present secondary material of the advertising campaign to responder users. This tracking and processing makes extensive use of the responder list 102. In some examples, it is desirable to maintain or otherwise process the responder list 102 “in the background” and not directly in processing that is carried out based on receipt of an event 104 to initiate display of an advertisement of the advertising campaign.

In some examples, the processing of step 120 (to cause the secondary material to be presented) may be entered independently of an advertisement display event 104. This is shown in FIG. 1 as a dashed arrow 122. For example, even if the user does not perform a search with keywords to cause the advertisement display event 104 corresponding to the advertising campaign, or does not browse to a web page with keywords to cause the advertisement display event 104 corresponding to the advertising campaign, the secondary material may be cause to be displayed at an appropriate time (e.g., a certain amount of time after the initial response). For example, the record in the responder list 102, for the particular responder user, indicates the time at which the responder user responded to the primary advertisement of the campaign. The responder list may be processed such that, after a particular amount of time has passed since the response to the primary material, the secondary material is caused to be displayed.

As another example, as mentioned above, the processing shown in the right side of FIG. 1 is to selectively delete responders from the responder list 102 (or to otherwise indicate not to provide secondary advertising material to particular responders). This is an example only, and other types of processing may be carried out in a similar manner. Turning back to FIG. 1, processing at step 124 is to determine if a particular responder user indicated in the responder list 102 should be removed from the responder list 102 due to the responder user being characterized as outside the “warm” period for the campaign.

That is, in the step 124 processing, it is determined if the present time (i.e., the time that the step 124 processing is taking place) is after the time at which the responder user responded to the primary advertisement by a particular amount of time. The particular amount of time may be configurable on an advertising campaign basis, and may reflect a judgment as to an amount of time after which a lead (i.e., the responder user who responded to the primary advertisement) is unlikely to ever respond to the secondary advertisements. While not shown in FIG. 1, other conditions may also be used to determine that the indication of the responder user is to be deleted from the responder list 102.

Using the specific FIG. 1 example, if it is determined at step 124 that the present time is after the “warm” time for the particular responder user, then processing continues at step 126, where the indication of the particular responder user is removed from the responder list 102; processing then continues at step 124 for another responder user indicated in the responder list 102. If it is determined at step 124 that the present time is not after the “warm” time period for the particular responder user, then step 124 processing is repeated for another responder user indicated in the responder list 102.

It can be seen, then, that an advertising campaign may be controlled to coordinate the display of primary material and of secondary material, as appropriate, to users that respond to the primary material. In addition, as mentioned above, the responder indications may be maintained in a decentralized manner, e.g., as cookies associated with each user client. Thus, the maintenance may be more opportunistic, taking place for a particular user when the cookie for that user is accessible, such as when an event 104 occurs, or when a related web page is being viewed.

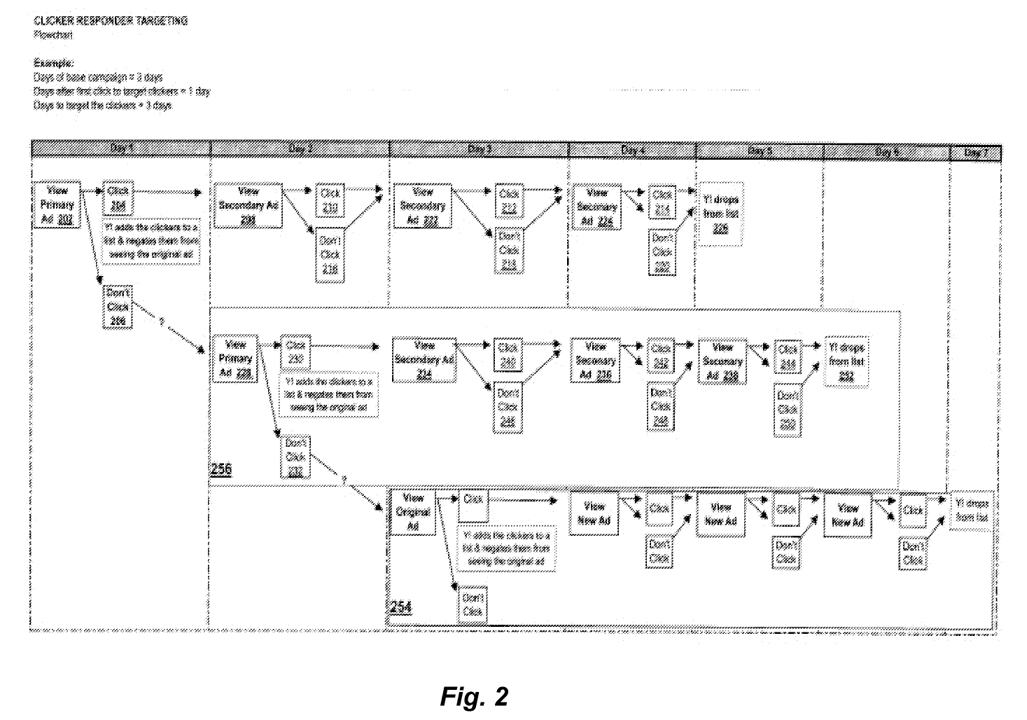

Having broadly described an example processing flow for responder targeting in an advertising campaign, we now discuss some simplistic examples with reference to FIG. 2. FIG. 2 illustrates some simplistic example timelines for processing of an advertising campaign. We describe the FIG. 2 example in the context of the FIG. 1 flowchart. Some of the parameters of the FIG. 2 example advertising campaign are that the primary portion of the campaign (i.e., the time during which primary advertisements may be displayed) is three days. There is a wait period of one day (block 118 in FIG. 1), after a response to a primary advertisement, to present the secondary advertisement to the responder. Finally, the secondary portion of the campaign (i.e., the time during which secondary advertisements may be displayed to a particular responder user) is three days.

Turning now to FIG. 2, block 202 represents a primary advertisement being displayed to a particular user (roughly corresponding to step 108 of the FIG. 1 flowchart). For example, as discussed above, the primary advertisement (as well as the secondary advertisement) may be a result of processing a search query or a result of processing content caused to be displayed by user action with respect to a browser program of a client computer. Blocks 204 and 206 represent the different paths the user may take. Block 204 represents the user responding to the primary advertisement (roughly corresponding to the “no” path from step 110 in FIG. 1), whereas block 206 represents the user not responding to the primary advertisement (roughly corresponding to the “yes” path from step 110 in FIG. 1).

Block 208 in FIG. 2 represents a secondary advertisement being displayed, based on the user responding to the primary advertisement (block 204). Note that the secondary advertisement is displayed (block 208) not less than one day after the user responds to the primary advertisement (block 204). Thereafter, whether the user responds to the secondary advertisement (blocks 210, 212 and 214) or not (blocks 216 and 218), the secondary advertisement is displayed (blocks 222 and 224). Block 226 represents the user being dropped from the responder list, given the three days (the three day “warm” time period in this example) that have passed since the user responded to the primary advertisement (block 204).

Going back to block 206, as discussed above, this block represents the user not responding to the primary advertisement. As a result, the primary advertisement is displayed again (block 228). Like blocks 204 and 206, blocks 230 and 232 respectively represent the responding to the primary advertisement (block 230) and not responding to the primary advertisement (block 232).

Blocks 234, 236 and 238, resulting from the user responding to the primary advertisement at block 230, parallel the blocks 208, 222 and 224 resulting from the user responding to the primary advertisement at block. Similarly, blocks 240, 246, 242, 248, 244 and 250 parallel the blocks 210, 216, 212, 218, 214 and 220. In addition, block 252 parallels block 226.

Finally, going back to block 232, the blocks that follow—collectively, indicated by reference numeral 254—parallel the blocks collectively indicated by reference numeral 256.

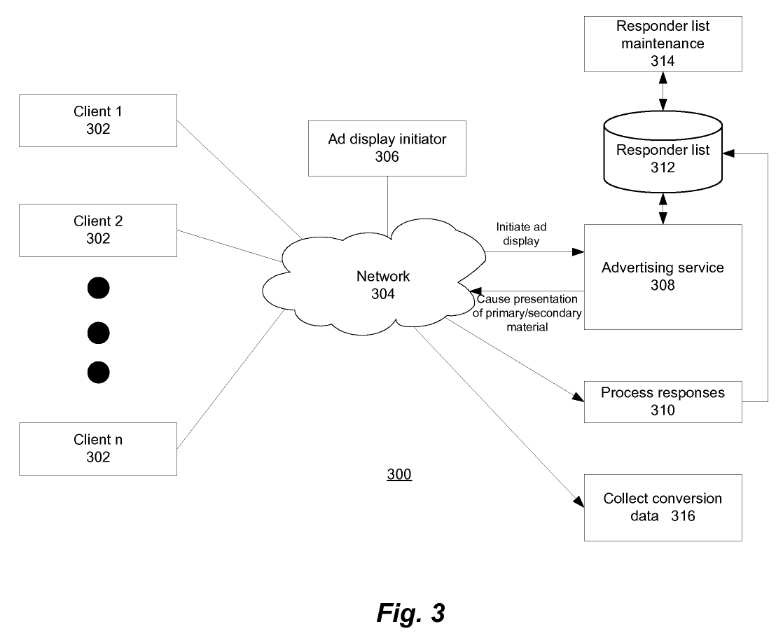

Having described a method and an example of the method for an advertising campaign having particular parameters, we now describe, with reference to FIG. 3, an example architecture of a system in which the method may operate. Turning now to FIG. 3, a plurality of client devices 302 are connected to a communication network 304 such as the internet. It is the client devices 302 on which the primary and secondary advertisements are ultimately caused to be displayed and via which a user responds to the advertisements. Block 306 generically represents functionality that initiates display of an advertisement, such as resulting from a sponsored search or context-based advertising display on a web page. A signal indicating initiating display of an advertisement is provided to the advertising service 308.

In general, in the FIG. 3 example, the processing at the left side of FIG. 1 takes place within advertising service 308. The advertising service 308 provides a signal to one or more client devices 302 to cause display of a primary advertisement or a secondary advertisement of the advertising campaign. Block 310 includes functionality to process responses, provided from client devices 302, to advertisements that are displayed on the client devices. The storage icon 312 represents the responder list (102, in FIG. 1). The responder list 312 is updated based on the response processing at block 310. Block 314 represents functionality to maintain the responder list, such as the processing at the right side of FIG. 1. Finally, block 316 represents functionality to collect conversion data (used, for example, at the decision step 112 in FIG. 1).

In can be seen, then, that a method and system has been described in which, by selectively targeting responders to primary media of an advertising campaign, according to particular criteria relative to the response to the primary media, with secondary media of the advertising campaign, the success of the advertising campaign may be accentuated.

What is claimed is:

1. A method of managing presentation of media of a particular campaign via a network to which a plurality of client computers are connectable, wherein the particular campaign is to present media of the campaign to the client computers for response evocation, the method comprising:
receiving an event indicating that media of the campaign is to be provided to a particular client computer via the network;
processing indications of responses to primary media of the campaign and, based thereon and in response to receiving the event indicating that media of the campaign is to be provided to the particular client computer, selectively providing one of primary media of the campaign and secondary media of the campaign to provide to the particular client computer via the network; and
automatically maintaining the indications of responses based at least in part on whether the particular client computer responds to the primary media of the campaign.

2. The method of claim 1, further comprising:
preventing the secondary media of the campaign from being provided to a particular client computer who has responded to primary media of the campaign until a particular condition is met.

3. The method of claim 2, wherein:
the particular condition is passage of a particular amount of time from the particular client computer responding to primary media of the campaign.

4. The method of claim 1, wherein:
the step of automatically maintaining the indications of responses includes removing an indication of a particular client computer responding to primary media of the campaign based on occurrence of a particular condition.

5. The method of claim 4, wherein:
the particular condition includes passage of a particular amount of time since the particular client computer responded to primary media of the campaign.

6. The method of claim 1, further comprising:
preventing the secondary media of the campaign from being provided to a particular client computer who has responded to primary media of the campaign until a first particular condition is met;
wherein the step of automatically maintaining the indications of responses includes removing an indication of a particular client computer responding to primary media of the campaign based on occurrence of a second particular condition.

7. The method of claim 6, wherein
the first particular condition is passage of a first amount of time from the particular client computer responding to primary media of the campaign; and
the second particular condition is passage of a second amount of time since the particular client computer responded to primary media of the campaign.

8. The method of claim 7, wherein:
the indications of responses are maintained in a centralized manner.

9. The method of claim 7, wherein:
the indications of responses are maintained in a distributed manner, such that each particular client computer handles maintaining indications of responses from that client computer.

10. The method of claim 1, wherein:
the event indicating that media of the campaign is to be provided to the particular client computer is a result of a search query that corresponds to the advertising campaign.

11. The method of claim 1, wherein:
the event indicating that media of the campaign is to be provided to the particular client computer is a result of action by the client computer to cause a browser to display a page whose content includes keywords that correspond to the advertising campaign.

12. A computing device operable to perform the method of claim 1.

13. A system configured for displaying information and accompanying advertising material, comprising:
a display generator configured to process signals indicative of user actions at a plurality of client computers, and to cause, based on a particular signal associated with a particular client computer, the display of information, by that particular client computer, relevant to the particular user action of which that particular signal is indicative and to also cause display of advertising material relevant to the displayed information;
a media selector configured to process indications of responses to primary media of the campaign, from the plurality of client computers, and, based thereon and in response to receiving the particular signal associated with the particular client computer, selectively providing one of primary media of the campaign and secondary media of the campaign to provide to the particular client computer via the network; and
a response indication maintainer configured to automatically maintain the indications of responses based at least in part on whether the particular client computer responds to the primary media of the campaign.

14. The system of claim 13, wherein:
the display generator is configured to prevent the secondary media of the campaign from being provided to a particular client computer who has responded to primary media of the campaign until a particular condition is met.

15. The system of claim 14, wherein:
the particular condition is passage of a particular amount of time from the particular client computer responding to primary media of the campaign.

16. The system of claim 13, wherein:
response indication maintainer is further configured to remove an indication of a particular client computer responding to primary media of the campaign based on occurrence of a particular condition.

17. The system of claim 16, wherein:
the particular condition includes passage of a particular amount of time since the particular client computer responded to primary media of the campaign.

18. The system of claim 13, wherein:
the display generator is configured to prevent the secondary media of the campaign from being provided to a particular client computer who has responded to primary media of the campaign until a first particular condition is met;
wherein the response indication maintainer is further configured to remove an indication of a particular client computer responding to primary media of the campaign based on occurrence of a second particular condition.

19. The system of claim 18, wherein
the first particular condition is passage of a first amount of time from the particular client computer responding to primary media of the campaign; and
the second particular condition is passage of a second amount of time since the particular client computer responded to primary media of the campaign.

20. The system of claim 19, wherein:
the response indication maintainer is configured to maintain the indications of responses in a centralized manner.

21. The system of claim 19, wherein:
the response indication maintainer is configured to maintain the indications of responses in a distributed manner, such that each particular client computer handles maintaining indications of responses from that client computer.

22. The system of claim 13, wherein:
the event indicating that media of the campaign is to be provided to the particular client computer is a result of a search query that corresponds to the advertising campaign.

23. The system of claim 13, wherein:
the event indicating that media of the campaign is to be provided to the particular client computer is a result of action by the particular client computer to cause a browser to display a page whose content includes keywords that correspond to the advertising campaign.
